(19) United States
(12) Patent Application Publication
(10) Pub. No.: US 2019/0281558 A1
(43) Pub. Date: Sep. 12, 2019

(54) ACTIVE COMPONENT VALIDATION IN A SECURE COMMUNICATION DEVICE

(71) Applicant: MAGIC MOBILE COMMUNICATIONS HOLDINGS, LLC, WESTBURY, NY (US)

(72) Inventors: James M. Wu, Great Neck, NY (US); Joseph DiRenzo, Westbury, NY (US); Victor Wang, Westbury, NY (US); Dee Jae Diliberto, Westbury, NY (US)

(21) Appl. No.: 16/295,926

(22) Filed: Mar. 7, 2019

Related U.S. Application Data
(60) Provisional application No. 62/639,828, filed on Mar. 7, 2018.
(60) Provisional application No. 62/639,830, filed on Mar. 7, 2018.
(60) Provisional application No. 62/639,833, filed on Mar. 7, 2018.

(51) Int. Cl. H04W 52/02; H04W 12/08; H04L 9/06; H04L 9/32

(52) U.S. Cl. CPC H04W 52/0274; H04L 9/3247; H04L 9/0643; H04W 12/08

(57) ABSTRACT

A communication device such as a cellphone or tablet may be configured to allow individual components to be selectively disabled, using for example, airgap switches. When the component is re-enabled a security check is performed to confirm that the component was not altered prior to continuing full operation of the device. The security check may include running a checksum over the component's firmware, comparing a hash of the firmware to an expected value, and checking a digital signature of the firmware.

### CLAIM OF PRIORITY

This application claims priority to U.S. Provisional Application 62/639,828 filed Mar. 7, 2018, U.S. Provisional Application 62/639,830 filed Mar. 7, 2018, and U.S. Provisional Application 62/639,833 filed Mar. 7, 2018, the entire contents of which are incorporated by reference for all purposes.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Communication devices, particularly smartphones offer many conveniences from making calls, staying connected on social media, and getting location-based information. At the same time, it is becoming increasing difficult to ensure that unauthorized parties also do not have access to the features and functions of the smartphone in a breach of personal privacy.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

A personal communication device may provide for a user to disable individual components of the communication device, for example, to prevent malicious or unintentional eavesdropping or location tracking. While one of these components is disabled, tampering of a component may occur without other systems, such as a download manager being aware of the changes. When the component is reactivated, the communication device may validate one or more characteristics of the component before it is allowed to return to service.

### BRIEF DESCRIPTION OF THE DRAWINGS

FIG. 1 is a block diagram illustrating the operating environment for the communication device in accordance with the current disclosure;

FIG. 2 is a block diagram illustrating an embodiment of a communication device of FIG. 1 in accordance with the current disclosure;

FIG. 3 is a diagram illustrating an airgap switch in accordance with the current disclosure;

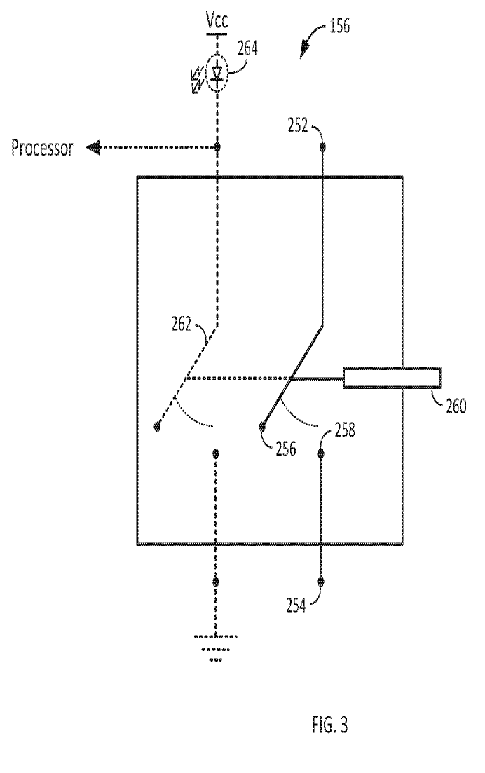

FIG. 4 is a block diagram illustrating an aspect of the communication device of FIG. 2 in accordance with the current disclosure; and

FIG. 5 is a flowchart of a method of operating a communication device in accordance with the current disclosure.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

Communication devices such as smartphones and tablets have become ubiquitous in our society. They are used for everything from a simple phone call to social media contacts to banking. The devices provide conveniences not contemplated even 15 years ago. These devices also have some drawbacks not fully comprehended as the technology developed. Among these may be ubiquitous location tracking without the knowledge or consent of the operator, identity theft or loss of personal data due to compromised software, and/or eavesdropping through a device's microphone and camera. In some cases such surveillance may occur even when the device appears to be shut down or in a limited communication state such as “airplane mode.”

While an ability to selectively disable individual components may provide almost certain prevention of some of these vulnerabilities, should a device be tampered with while it is offline or out of view of the rest of the communication device, the compromised component may pose even more of a threat if it is subsequently allowed to return to service. A compromised component may allow the communication device's other components and primary executable code base to be subverted by the introduction of Trojan software, deliberate malfunctions, keystroke logging, and more.

The ability to not only selectively disable a component, such as a GPS receiver or WiFi device, but also to confirm its integrity before allowing the component to return to active service after being disabled helps to create a more secure environment for the user.

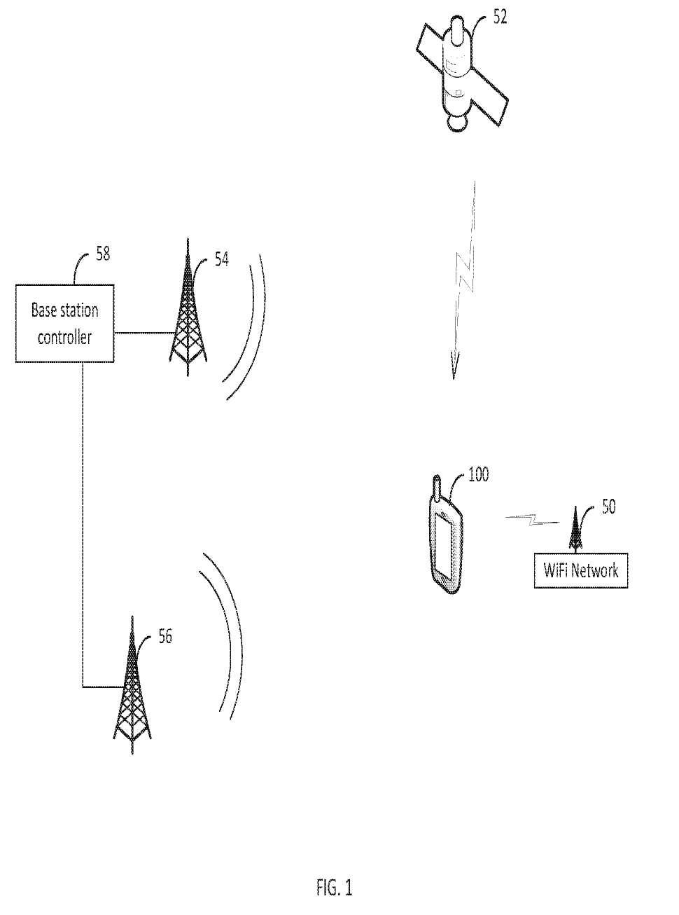

FIG. 1 is a block diagram illustrating an exemplary operating environment for a communication device 100 in accordance with the current disclosure. The communication device 100 may be a smartphone, a tablet, a personal digital assistant, or other electronic device capable of communication with an outside entity via a communication channel, for example, a cellular network or WiFi (IEEE 802.11) connection. The communication device 100 may also include one or more location services such as a GPS system and/or a dead reckoning system using a one or more of a compass, accelerometer, gyroscope, etc.

The communication device 100 may be in communication with a Wireless Fidelity (WiFi) network, for example, a short range network defined under the IEEE 802.11 family of specifications. Other short range networks may include Bluetooth, Bluetooth Low Energy (BLE), and other near-field communication (NFC). The communication device 100 may also be in communication with one or more cellular telephone towers 54, 56. The communication device 100 may receive a signal from one or more of the constellation of global positioning satellites 52 used to develop accurate location data at the communication device 100. A base station controller 58 may capture signals from the communication device 100 via one or both of the cellular telephone towers 54, 56.

As may be apparent, any of these communication mechanisms may be used separately or in combination to track the location of the communication device 100, either in real time or after gaining access to the communication device 100 itself. For example, the base station controller 58 may track movement of the communication device 100 through the coverage areas of an individual tower 56 or may develop location information based on signal strength of the communication device 100 at two or more base station devices.

WiFi networks 50 may be linked to form a grid of hotspots (not depicted) that can use registration data to track a communication device 100 without a user of the communication device 100 even connecting to any of the networks in the grid. Similarly, Bluetooth access points in stores and Internet of Things devices such as appliances can track a communication device 100 without the user's knowledge or permission.

GPS data may be relayed to an external device via cellular or short range data connections if one or more applications (apps) on the communication device 100 openly or surreptitiously collect such information. Even absent an offending app, the GPS data may be stored as a function of the device operating system and may be available to anyone with access to the communication device 100 even for a short period of time. As discussed more below, other sensors and transducers may be used to infer location via dead-reckoning, image matching, background sounds, etc.

Beyond the compromise of location, the sensors and transducers may be coopted to record and/or transmit audio and video from the communication device 100 even when these devices are presumed to be off or an associated activation light (e.g. for a camera) is not illuminated. The compromise of personal information described above may, at least in part be due to the use of software to control each of the above-described functions and internal systems, including indicator lights. As described below, the communication device 100 may be specially adapted to minimize or eliminate such threats related to the unauthorized divulging of personal information, location, and activities.

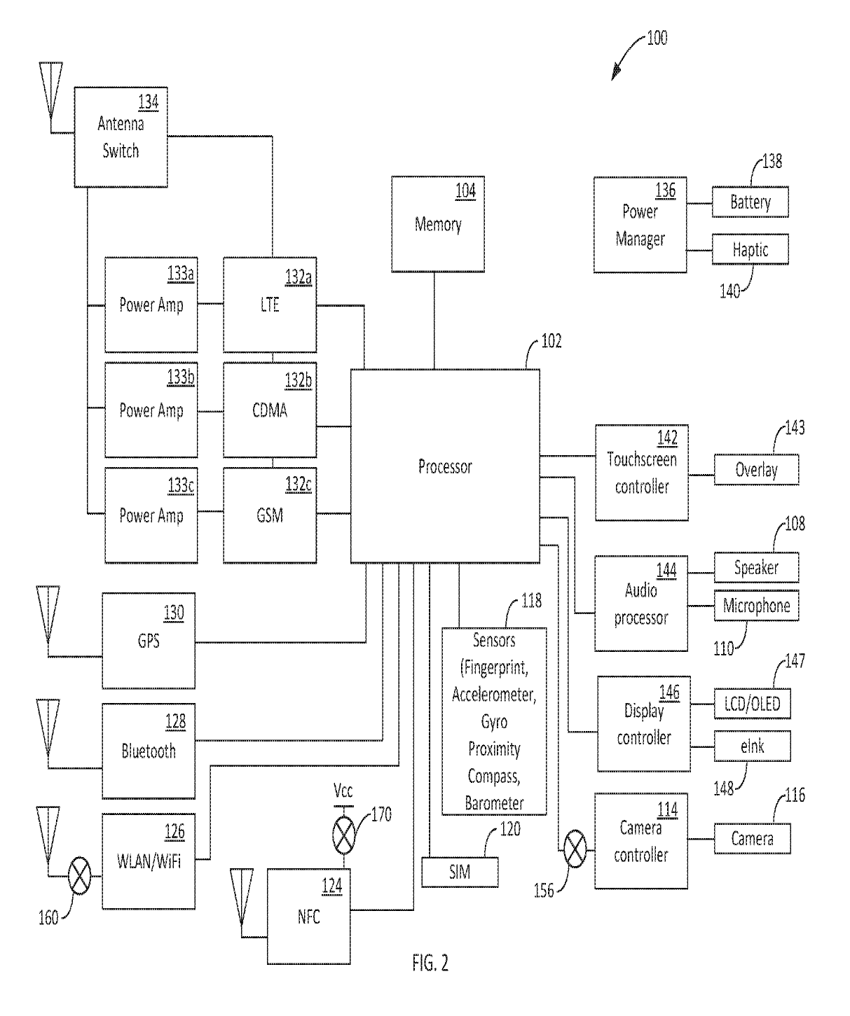

Turning to FIG. 2, a block diagram illustrating a communication device 100 in accordance with the current disclosure is discussed and described. The communication device 100 may include a processor 102 and memory 104. The processor 102 may use executable instructions and data stored in the memory 104 to perform various functions related to the operation of the communication device 100. In some embodiments, the functions processor 102 may be divided among multiple special-purpose processors (not depicted). The memory 104 may be a combination of volatile and non-volatile memories, including solid state flash memory and random access memory. The memory 104 may be or include any of a number of hardware memory implementations but does not include propagated media or carrier wave memories.

A power manager 136 may control distribution of power from a battery 138 in order to conserve battery life by automatically disabling selected circuits or reducing power to the display. A haptic device 140 may include a motor to create a vibration in the communication device 100 to alert a user to a message or condition.

Interactions with a user may be supported by, in this embodiment, a number of components including a touchscreen controller 142 coupled to a capacitive screen overlay 143 to allow a user to generate input signals via gestures. An audio processor 144 may generate audio frequency signals for output via a speaker 108 and may receive audio frequency signals generated by a microphone 110. In an embodiment, the audio processor may include one or more coder/decoders or codecs for processing the audio signals. A display controller 146 may interface to one or more visual displays such as an LED or OLED display 147 and/or an elnk display 148. The display controller 146 may include display memory for mapping individual pixels for color and brightness.

A camera controller 114 may interface to a camera 116 allowing the communication device 100 to capture images and video. In various embodiments a second camera (not depicted) may be present and may share the camera controller 114 for setting exposure, image processing, compression, stitching, editing or other functions. In some embodiments, some or all of those functions may be supported by the processor 102. In the illustrated embodiment, an airgap switch 156 may allow the camera controller 114 to be disabled by disconnecting power, a signal line to the processor, or both via a manually operated mechanism that opens or closes contacts in the airgap switch. Because this airgap switch 156 and other similar airgap switches discussed below are not under software control, but operate only with an manual operation, the camera controller 114 and other components may be positively disabled so that a breach in any software of the communication device 100 cannot override its corresponding component's function.

Various sensors 118 may be installed on the communication device 100 for interaction with the environment including, but not limited to, an accelerometer, gyroscope, proximity sensor, compass, and barometer. The sensors 118 may also include a fingerprint reader that may be used for secure access to the communication device 100, device services, applications, etc.

A subscriber identity module (SIM) 120 may be used in some communication devices to support communications with a service provider or carrier. The SIM 120 may include subscriber data, stored information such as contacts, and cryptographic secrets used, among other things, to validate communication sessions.

Various signaling devices, may be used to receive and/or send signals with external entities. The signaling devices may include a near field communication (NFC) device 124 such as Bluetooth Low Energy (BLE). NFC communications may be used for very short range communications, such as using the communication device 100 for payments at a point of sale device. A WiFi device 126 may be used for local area communications via any of a number of IEEE 802.11 standards. A Bluetooth device 128 may communicate over shorter ranges and may be primarily used for communication with accessories such as wireless speakers and headphones.

A GPS receiver 130 uses signals from a number of satellites in the GPS satellite constellation to generate a location of the communication device 100. While the GPS receiver 130 is not capable of sharing that location information, as discussed above, the location information may be stored, used, and/or transmitted by one of the other two-way communication devices.

Wide area communication may be accomplished through multiple cellular telephone technologies. In the illustrated tri-mode communication device 100 radio frequency (RF) processors may format and modulate data for transmission or demodulate received data. The communication device 100 may include an LTE (long term evolution) RF processor 132a, a CDMA (code division multiple access) processor 132b, and a GSM (global system for mobile) processor 132c. Each of the transmit portions of the RF processors 132a, 132b, 132c, may have a corresponding power amplifier 133a, 133b, 133c for increasing the power output of the communication device 100 to a level set by the system in which the communication device 100 is operating. Each of the RF processors 132a, 132b, 132c also has a receive portion that receives radio frequency signals and processes those signals to baseband data for ultimate conversion to voice or data.

The transmit and receive portions of the RF processors may share a common antenna via an antenna switch 134 that couples either the receiver or the transmitter to the antenna so that the high power output of the transmitter does not couple into the receiver and cause damage. In some embodiments a circulator (not depicted) may be used instead of an antenna relay 134.

Air Gap Switches

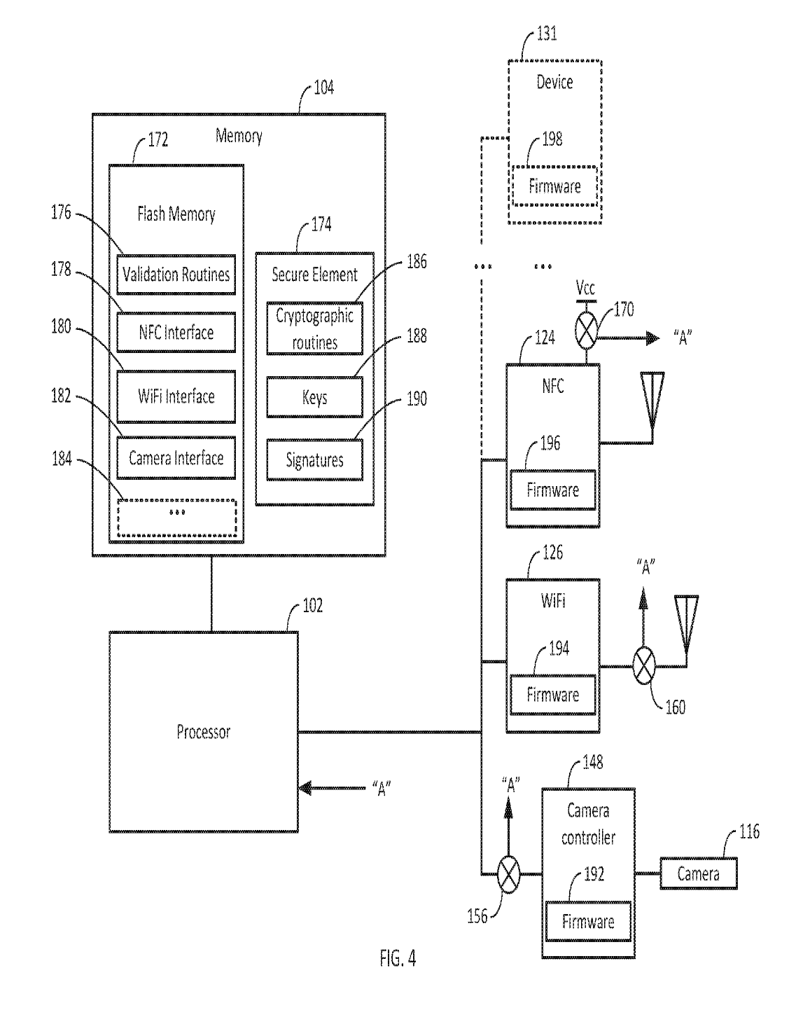

Turning briefly to FIG. 4, one embodiment of the airgap switch 156 is illustrated. The airgap switch 156 may include input and output terminals 252 and 254. An armature 256 may selectively be connected to a contact 258 via movement of a lever 260, knob, button or the like. The lever 260 may be manually operated, that is, by physical movement caused by a user of the communication device 100. In an embodiment, the lever action is bistable so that one activation of the lever 260 opens the circuit and another activation of the lever 260 closes the circuit, similar to a simple light switch. In another embodiment, the lever 260 may be a momentary switch that either closes or opens the circuit only with the lever 260 is held in place. In yet another embodiment, the lever 260 may be activated by an electromagnet which itself may be manually controlled.

While the illustrated embodiment uses mechanical switches for electrical circuits, an alternate embodiment may include optical switches for use in switching optical signals. The optical switch may be a microelectromechanical system (MEMS) switch such as are commercially available from commercial sellers such as DiCon Fiberoptics, Inc. and Agiltron Inc.

One embodiment of the airgap switch 156 may also include an indicator light 264 that operates in concert with the armature 256. As shown in this illustration, the light 264 will activate when the armature 256 closes the circuit. In another embodiment, the light 264 may illuminate when the circuit is open. This may be accomplished either mechanically or electrically, for example using an inverter. The variations of the operation of the light 264 will be apparent to one of ordinary skill in electric circuitry. In an embodiment, the processor 102 may be coupled to the switch 156 so that the operating system or an application installed on the communication device 100 may be able monitor the state of the switch 156 without being able to influence operation of the switch 156.

Returning to FIG. 2, in addition to the airgap switch 156 discussed above, other airgap switches that are the same as or similar to the airgap switch 156 may be installed in the communication device 100. An airgap switch 170 is illustrated in a position to interrupt power to the NFC device 124 as a means for disabling that device. Similarly, an airgap switch 160 is illustrated in a position to interrupt signals to or from the WiFi device 126 to its corresponding antenna. These embodiments are used for the sake of illustration. In other embodiments, power, signal connections, or both may be used to disable any of the components of the communication device 100, including the battery 136 and processor 102. However, in the interest of brevity and to reduce the risk of obscuring the relevant principles disclosed herein, only these three airgap switches are discussed further.

Validation Checks

A partial block diagram of the communication device 100 is illustrated in FIG. 4 showing in more detail an embodiment in accordance with the current disclosure. The processor 102 is shown coupled to the memory 104 and the NFC device 124, the WiFi device 126, and the camera controller 148. As illustrated in FIG. 2, the NFC device 124 may be manually disabled by interrupting its power via airgap switch 170. The WiFi device 126 may be disabled by manually disconnecting the signal line coupled to its antenna. In the third case, the data connection from the camera controller 148 to the processor 102 may be interrupted by the airgap switch 156. The switches 156, 160, and 170 represent three principle techniques for disabling components of the communication device 100, although other techniques may be used. Each switch 156, 160, 170 is illustrated as having a sense output (“A”) coupled to the processor 102 to allow the state of a component to be read or polled. Acknowledging that other components exist in the communication device 100, the device 131 is illustrated in dashed lines.

In an embodiment, each illustrated component 124, 126, 148 may use embedded software, sometimes referred to as firmware, to perform their respective functions. The NFC device 124 may use firmware 196, the WiFi device 126 may use firmware 194, and the camera controller 148 may use firmware 192 to support the various functions associated with their respective operation. However, when a component is disabled, it may be susceptible to tampering by, for example, unauthorized changes to its firmware. In an embodiment, each firmware 192, 194, 196 may be verified when it's respective component 148, 126, 124 is re-enabled. In addition, various serial numbers or other hardware-specific identifiers may be confirmed during the validation process.

Turning to the memory 104, in order to accomplish these checks, the memory 104 may include one or more special validation routines 176. The memory 104 may also contain interfaces or applications supporting each component. For example, the memory 104 may have an NFC interface 178, a WiFi interface 180 and a camera interface 182.

Each of the interfaces 178, 180, 182 may support functions of their respective components, such as data formatting, protocol management, error handling, authentication as needed, login interactions as needed (e.g., WiFi hotspot login), and cryptographic processing.

The memory may also include a secure element 174 that may be used perform cryptographic functions on behalf of the above components using various cryptographic routines for signing, signature verification, encryption, decryption, and hashing among others. Some of these functions may involve the use of cryptographic keys 188 such as PKI private keys and financial instrument symmetric keys, financial tokens, and/or access tokens. The secure element may also store digital signatures of various software or firmware installed on the communication device 100. The digital signatures may, in an embodiment be a hash of the firmware, signed with the private key of the firmware developer. This hash approach allows an appropriate validation routine 176 to perform a hash of a firmware, e.g. firmware 194, and compare that hash to the digitally signed hash provided by the manufacturer or other responsible party.

Validation Process

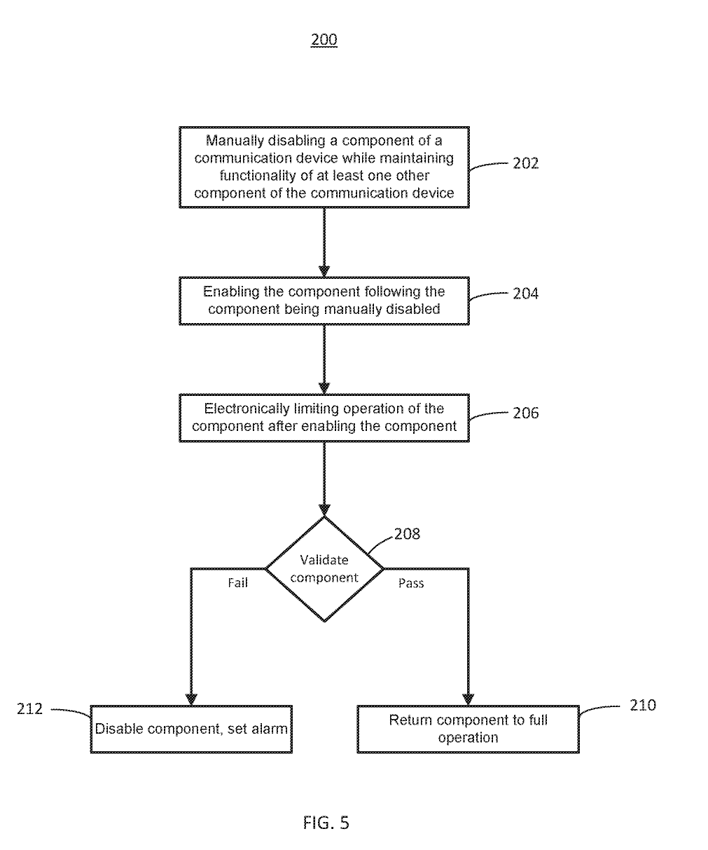

The implementation of this validation process may be illustrated via the method 200 shown in the flowchart of FIG. 5. In some cases, verification of at least an operating system and boot software may be performed when the communication device 100 is powered on, but the ability to re-validate components during operation and particularly at the time of re-activation after being disabled brings a new level of security to the operational characteristics of the communication device 100.

At block 202, a component, e.g. the WiFi device 126 may be disabled by the manual activation of an airgap switch 160 which disconnects its antenna. With the antenna disconnected no signals may be sent or received, rendering the WiFi device 126 unable to communicate and as a result, also unable to transmit information about the device or its user to an unauthorized party, or even an authorized party such as a chain store's WiFi network. The processor 102 may sense the state of the switch and log the event disabling the WiFi device 126. At block 204, the WiFi device 126 may be re-enabled by a subsequent manual operation to the airgap switch 160. For example, the antenna may be reconnected to the WiFi device 126.

At block 206, the WiFi interface 180 or a related function may block use of the WiFi device 126 pending validation of the device's firmware 194, serial number, or other identifying characteristics. Then at block 208, the WiFi interface 180 may call a corresponding validation routine 176 to perform the validation in conjunction with data stored in the secure element 174. For example, a serial number of the device 126 may be read and compared to an expected serial number stored in the secure element 174. Instead of or in addition to the serial number check, a hash of the firmware 194 may be calculated using any of a number of hashing algorithms such as SHA-256. The hash may be compared to a digitally signed hash stored in the secure element 174. In an embodiment, the validity of the digital signature may be checked by downloading a certificate revocation list (CRL) from the appropriate certificate authority. Obviously, other steps may be taken to authenticate the device 126 beyond or instead of those discussed.

When the validation passes, the “pass” branch from block 208 may be taken to block 210 and the component may be restored to full operation. When the validation fails, the ‘fail’ branch may be taken to block 212 where the component may be kept in a disabled mode and an alarm may be set to alert the user or a monitoring agency that the component may have been compromised.

In another embodiment, the disabled component, e.g., the WiFi device 126 may perform a validation of an aspect of the communication device 100 before restarting its services. For example, the WiFi device may request the hardware identification number of the processor 102. If the expected value is returned, the WiFi device 126 may continue its operation. If the expected value is not returned or the value returned is not what is expected, the WiFi device 126 may take itself offline. For example, if the main system software was tampered with while the WiFi device 126 was inactive, the new main system software may not be programmed to respond to such as request, indicating to the WiFi device 126 that tampering has occurred.

A technical effect of the disclosure system and method is the use of manual switches for the activation and deactivation of specific components of the communication device 100. Another technical effect is the use of in-process validation of components before being allowed to return to service after the component has been disabled and then re-enabled. This adds a significant increase in the security of the edge components of the communication device 100, that is, those components that directly interact with the outside world.

The ability to positively shut off certain components of a personal communication device and then to validate that component before returning it to service benefits users by ensuring that features and functions of the device are not used without the device owner's knowledge either inadvertently or as the result of the device being compromised.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A communication device configured for secure operation, the communication device comprising:
a processor;
a program memory coupled to the processor, the program memory including a plurality of applications in the form of executable code;
an external interface coupled to the processor that captures information from an environment external to the communication device;
a manual switch mechanism that is manually operated to selectively disable operation of the external interface while maintaining operation of other components of the communication device; and
a validation module that confirms an integrity of the external interface when the external interface is re-enabled after being selectively disabled via the switch mechanism.

2. The communication device of claim 1, wherein the external interface is one of a transducer interface coupled to the processor; a transducer coupled to a corresponding transducer interface; a cellular communication processor coupled to the processor; and a local area communication device coupled to the processor.

3. A method of securing a communication device following selectively disabling a component of the communication device, the method comprising:
manually disabling a component of the communication device while maintaining functionality of at least one other component of the communication device;
enabling the component following manually disabling the component;
electronically limiting operation of the component after enabling the component;
validating a security aspect of the component;
responsive to successfully validating the security aspect of the component, returning the component to full operation.

4. The method of claim 3, wherein manually disabling the component of the communication device comprises manually operating an airgap switch that disconnects power to the component.

5. The method of claim 3, wherein manually disabling the component of the communication device comprises manually operating an airgap switch that blocks an output of the component.

6. The method of claim 3, wherein validating the security aspect of the component comprises performing one of a checksum of a software of the component, a hash confirmation of the software of the component, or confirming a digital signature of the software of the component.
